(19) United States
(12) Patent Application Publication
(10) Pub. No.: US 2018/0155581 A1
(43) Pub. Date: Jun. 7, 2018

(54) TRANSFER TAPES AND RELATED METHODS

(71) Applicant: 3M INNOVATIVE PROPERTIES COMPANY, St. Paul, MN (US)

(72) Inventors: Michael L. Steiner, New Richmond, WI (US); Marie A. Boulos, West St. Paul, MN (US); Maria A. Appeaning, St. Paul, MN (US)

(21) Appl. No.: 15/567,104

(22) PCT Filed: May 4, 2016
(86) PCT No.: PCT/US2016/030646

§ 371 Date: Oct. 17, 2017

Related U.S. Application Data
(60) Provisional application No. 62/161,493, filed on May 14, 2015.

(51) Int. Cl. C09J 7/40; C09J 7/30; C09J 123/06; C09J 127/12; C09J 143/04; C09J 183/06

(52) U.S. Cl. CPC C09J 7/403; C09J 7/401; C09J 7/30; C09J 123/06; C09J 127/12; C09J 2483/005; C09J 183/06; C09J 2400/24; C09J 2423/045; C09J 2427/005; C09J 143/04

(57) ABSTRACT

Provided are methods of making a transfer tape in which first and second release coatings are disposed onto respective first and second major surfaces of a backing to provide a release liner, the first release coating comprising wax particles at least partially embedded in a polymeric layer. An adhesive precursor is coated onto the first release coating and the adhesive precursor and the release liner collectively irradiated with an electron beam to convert the adhesive precursor into an adhesive layer. Advantageously, the provided transfer tape can be wound into a roll and stored for long periods without exhibiting degradation of release properties attributable to either blocking or electron beam degradation of the liner release coating.

### FIELD OF THE INVENTION

The present disclosure relates to adhesive tapes, along with methods and assemblies associated thereof. The adhesive tapes of the present disclosure are, more particularly, adhesive transfer tapes.

### BACKGROUND

Pressure-sensitive adhesives (or PSAs) are substances that form a bond with an adjoining substrate upon application of force. PSAs can be engineered for a wide range of permanent and removable applications. Permanent applications include office labels, duct tape, automotive trim assemblies, sound and vibration damping films, and bonding solutions for portable electronic devices. Removable applications include, for example, removable notes, surface protection films such as transit tape, graphic materials, and wound dressings.

The chemical composition of these adhesives typically includes an elastomeric polymer blended with a suitable tackifier, which is generally a low molecular weight polymer having a high glass transition temperature. These components are polymerized, or cured, from low molecular weight precursors such as monomers and oligomers having chemically reactive end groups. Various polymerization mechanisms are known in art, including thermal curing, photocuring (e.g., ultraviolet light curing), and electron beam curing. Each of these mechanisms form covalent bonds capable of synthesizing high molecular weight polymers and interconnecting these polymers into resilient, crosslinked networks.

Electron beam curing of adhesive precursors provides technical advantages over alternative curing mechanisms. The electrons accelerated in this process directly ionize polymers without the need to add thermal or photosensitive initiators, which can impart an undesirable color or create contamination issues in sensitive applications. Another advantage of electron beam curing relates to its uniform energy deposition through the thickness of the adhesive and across the web. Electron beams can also penetrate through adhesive precursors containing strong light absorbers, such as carbon black, which interfere with photoinitiator induced curing. Finally, an electron beam source can be integrated into a continuous manufacturing process for adhesive tapes.

One kind of adhesive tape, known as a transfer tape, allows a user to deliver a controlled application of a pressure-sensitive adhesive onto a substrate from a release liner. The release liner preserves the integrity of the adhesive and also functions as a separator that prevents the adhesive from sticking to itself when stored in roll form. After use, the liner can be rewound back into its dispenser and eventually discarded. Transfer tapes differ from double-sided tapes in that the adhesive film applied onto the substrate has no backing and can thus be made significantly thinner. Until the adhesive is applied, the liner functions as its carrier.

### SUMMARY

The manufacture of a transfer tape poses special technical challenges that relate to its lined configuration. The rolled transfer tape construction as described above uses a double-sided liner, which can suffer from the problem of “blocking,” or the tendency of a liner to stick to itself when wound and stored in a rolled configuration. Release liners are made from smooth curable release coatings, typically of silicone, which are often not fully cured prior to storage. When these release coatings are placed in contact with each other, they can wet out against each other and chemically interact in a way that interferes with peeling the liner away from itself. When this occurs, portions of the release coating can split or even delaminate from the liner substrate, compromising liner performance.

A second issue relates to a phenomenon observed when electron beam processing conventional release liners. When a surface of a release liner is exposed to incident electrons, it can become brittle and overcured. This in turn can induce picking and fracturing of the release surface when the release liner is peeled from an adjoining adhesive layer, which again leads to a degradation in release performance. If any oxygen is present, electron beam irradiation can also form peroxy radicals which can persist after adhesive coating and also affect release performance. Poor release performance can also result in “liner confusion,” where the adhesive layer sticks to the wrong liner surface when unwinding the transfer tape from the roll.

Such technical challenges are of particular relevance when manufacturing electron beam processed transfer tapes. Because the adhesive compositions of these tapes are generally disposed on liners when cured, these liners should ideally resist blocking and electron beam induced degradation while providing acceptable release. Liner manufacturers have overcome this problem by implanting tiny silica or silicone resin particles on the surface of the release coatings. The addition of these anti-blocking materials, however, fail to remedy the persistent problem of unacceptably high release force observed in these release coatings after electron beam irradiation.

Another solution is to transfer the adhesive layer from its original, electron beam processed liner to a fresh liner after curing. Unsurprisingly, this is not preferred because discarding the old liner is wasteful and furthermore liner transfers result in increased release force in the finished tape, since adhesives in general only transfer from lower release force surfaces to higher release force surfaces.

The provided methods, articles, and assemblies, overcome all of the aforementioned shortcomings by incorporating wax particles into the release coating of one side of the liner, which was found to provide surprisingly consistent liner release properties, even after electron beam exposure. Advantageously, the provided transfer tapes can exploit adhesives curable only by electron beam and be stored for long periods without exhibiting degradation of release properties attributable to either blocking or electron beam degradation of the liner release coating.

In a first aspect, a method of making a transfer tape is provided. The method comprises: disposing first and second release coatings onto respective first and second major surfaces of a backing to provide a release liner, the second release coating comprising wax particles at least partially embedded in a polymeric layer; coating an adhesive precursor onto the first release coating; and collectively irradiating the adhesive precursor and the release liner with an electron beam to convert the adhesive precursor into an adhesive layer.

In a second aspect, a transfer tape is provided comprising: a release liner comprising: a backing having opposed first and second major surfaces; a first release coating disposed on the first major surface; and a second release coating disposed on the second major surface comprising wax particles at least partially embedded in a polymeric layer; and an adhesive layer disposed the first release coating, the adhesive layer being substantially free of thermal and photochemical initiators.

In the aforementioned cases, the transfer tape can be subsequently stacked or rolled such that the adhesive layer is placed into contact with both the first and second release coatings.

In a third aspect, a bondable assembly is provided comprising: a transfer tape as described above; and a substrate adhesively coupled to a major surface of the adhesive layer opposite that facing the first release liner.

### BRIEF DESCRIPTION OF THE DRAWINGS

Exemplary embodiments are described with reference to accompanying drawings as follows:

FIG. 1 is a cross-sectional side view of a primary component of a transfer tape according to a first exemplary embodiment;

FIG. 2 is a cross-sectional side view of a transfer tape including the component of FIG. 1;

FIG. 3 is a cross-sectional side view of a transfer tape according to a second exemplary embodiment;

FIG. 4 is a cross-sectional side view of a transfer tape according to a third exemplary embodiment;

FIG. 5 is a schematic diagram showing an exemplary process for making the component of FIG. 1; and

FIG. 6 is a schematic diagram showing an exemplary process for making the provided transfer tapes.

Repeated use of reference characters in the specification and drawings is intended to denote the same or analogous features or elements of the disclosure. It should be understood that numerous other modifications and embodiments can be devised by those skilled in the art, which fall within the scope and spirit of the principles of the disclosure. Figures may not be drawn to scale.

### DEFINITIONS

As used herein:

“adhesive” refers to polymeric compositions useful to adhere two adherends to each other;

“adhesive precursor” refers to a composition that is not itself an adhesive but upon further processing, such as by drying or curing, the composition forms an adhesive;

“release surface” refers to a surface that provides a low adhesive strength to adhesives, especially pressure sensitive adhesives;

“release liners” refers to articles containing at least one release surface; and

“substantially free” means having less than 0.1 weight percent of a given component therein based on the overall weight of solids.

### DETAILED DESCRIPTION

Described herein by way of illustration and example are embodiments of transfer tapes and lined adhesive assemblies, along with methods associated thereof.

As used herein, the terms “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

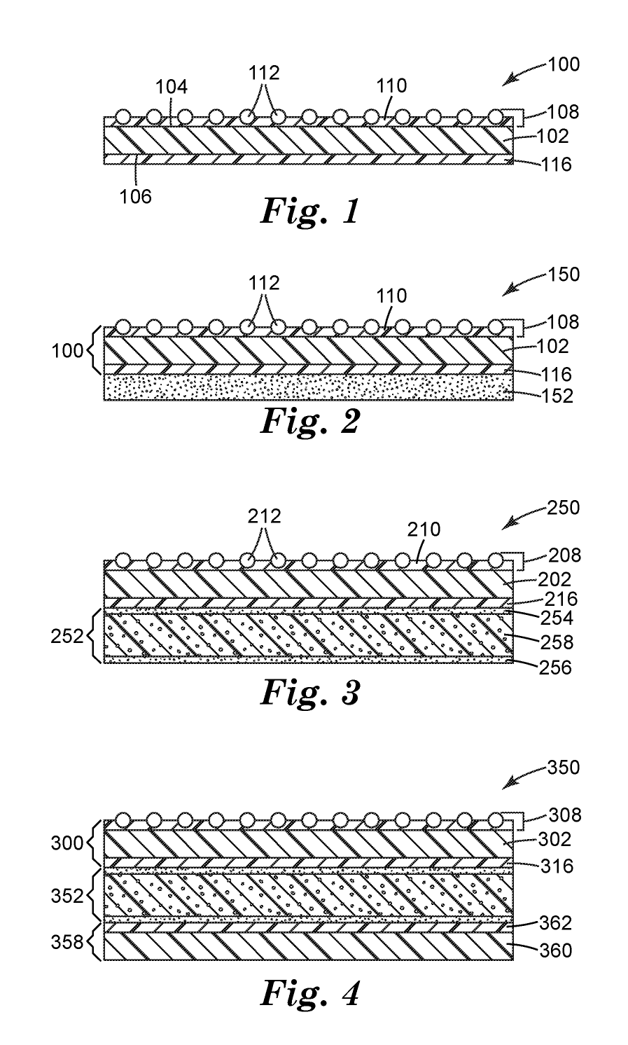

A component of an exemplary transfer tape is a release liner, herein designated by the numeral 100 and referred to in FIGS. 1, 2, 5 and 6. The release liner 100 generally includes a backing 102 having a first major surface 104 and an opposed second major surface 106.

The backing 102 can be made of any material capable of providing structural integrity to the release liner 100. For example, the backing 102 can be made from a nonwoven (e.g., paper), polymeric film (e.g., polyvinyl, polyolefin, polyurea, polyurethane, polyvinylchloride, or polyester film), foam, or metallized film. If a polymer film is used, it may be biaxially oriented to provide greater stiffness and strength. The backing 102 is preferably flexible and capable of being wound and stored in a rolled configuration.

Extending across and contacting the first major surface 104 is a first release coating 108 that facilitates detachment of an adhesive disposed thereon. As shown in FIG. 1, the first release coating 108 is comprised of a polymeric layer 110 and wax particles 112 that are at least partially embedded in the polymeric layer 110.

The polymeric layer 110 is preferably a continuous coating disposed on the backing 102, and made from a polymer that, in and of itself, provides a release surface with respect to one or more pressure-sensitive adhesives. Suitable release materials include, but are not limited to, low surface energy materials such as silicones, epoxy silicones cured by photo-acid generated crosslinking, fluorosilicones, silicone acrylates, perfluoropolyether and other fluorochemical materials, olefin materials, long-chain hydrocarbon-functional materials, and copolymers and mixtures thereof.

Exemplary silicones include those made by, for example, addition cure or condensation cure chemistries.

In addition cure chemistries, curing is achieved through the addition of Si—H across an unsaturated bond, i.e., hydrosilation. Advantageously, this mechanism uses precious metal catalysts (e.g., platinum catalysts) that are highly efficient. For example, even parts per million (ppm) of platinum enable facile hydrosilylation without producing undesirable by products.

Condensation cure chemistries achieve curing through the reaction of Si—OH and Si—H groups or Si—OH and Si—OH groups leading to the formation of Si—O—Si linkages and hydrogen gas or water. Exemplary systems include hydroxyl-functional polyorganosiloxanes and hydride-functional silanes. Typically, condensation cure silicone systems have been cured with tin-based catalysts. Such catalysts facilitate two major reactions, i.e., chain-extension reactions involving two silanol groups, and cross-linking or curing reactions involving a silanol group and a silicon hydride group. Details concerning these curing chemistries are described in NOLL, WALTER, CHEMISTRY AND TECHNOLOGY OF SILICONES, 386-436 (1968).

Other silicones that provide a release surface include moisture curable silicones that are cured using an acid-generated material. The acid, in turn, can be generated by ultraviolet light or thermal energy. Such silicone compositions include the reaction product of a reactive silane functional compound, dimethyl siloxane—[methyl-2-(ethoxydimethylsilyl)ethyl] siloxane copolymer, broadly described by Structure I:

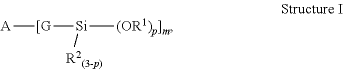

wherein G is —CH₂CH₂—, m is 6; p is 1; R¹ is —CH₂CH₃; R² is —CH₃; and A is as follows:

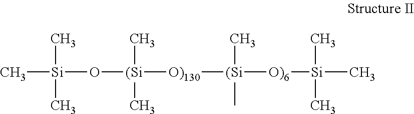

Another exemplary material for making release coatings can be described by Structure I wherein G is —CH₂CH₂—; m is 6; p is 3; R¹ is —CH₂CH₃; and A is Structure II above.

Yet another exemplary group of materials for making release coatings can be described by Structure I wherein G is —CH₂CH₂CH₂—HNC(O)NH—CH₂CH₂CH₂—; m is 2; p is 3; R¹ is —CH₂CH₃; and A is Structure III shown below

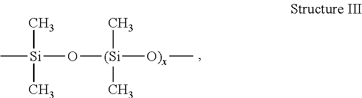

wherein the value of x ranges from 10 to 2000.

Further options and advantages of these moisture curable compositions are disclosed, for example, in U.S. Pat. No. 6,204,350 (Liu et al.). Alternatively, the polymeric layer 110 could also use any of the release compositions described, for example, in U.S. Pat. Nos. 6,780,484 (Kobe et al.) and 6,835,422 (Kobe et al.).

In FIG. 1, the wax particles 112 are only partially embedded in the polymeric layer 110, thus presenting a chemically heterogeneous composition at the surface of the first release coating 108. In other embodiments, at least some of the wax particles 112 may be fully embedded but have sufficient size to cause a two-dimensional array of bumps or protrusions to be expressed at the exposed surface of the first release coating 108.

As used herein, waxes are chemical compounds that are plastic (or malleable) at ambient temperatures, or around 25° C. Such compounds are generally lipids and melt above 45° C. to give a low viscosity liquid. Most waxes are insoluble in water but soluble in organic, nonpolar solvents. In some embodiments, waxes are organic compounds that characteristically consist of long alkyl chains. Natural waxes can contain esters of carboxylic acids and long chain alcohols or mixtures of substituted hydrocarbons, such as long chain fatty acids and primary alcohols. Synthetic waxes can be long-chain hydrocarbons that lack any functional groups.

In FIG. 1, the wax particles 112 may be comprised of a wax of modified high-density polyethylene (HDPE), modified polyethylene (PE), fluoropolymer such as polytetrafluoroethylene (PTFE), PTFE-modified polyethylene, polypropylene (PP), ethylene acrylic acid (EAA) copolymer, oxidized high-density polyethylene, or a copolymer or mixture thereof. As an option, it is possible to have a core made of one of the aforementioned waxes with a shell made from a different one of the aforementioned waxes.

Preferred waxes can have a melting temperature of at least 45° C., at least 50° C., at least 55° C., at least 65° C., or at least 75° C. Preferred waxes can have a melting temperature of at most 130° C., at most 110° C., at most 100° C., at most 90° C., or at most 80° C.

Preferred wax particles 112 include those sold under the trade designation POLYFLUO by Micro Powders Inc., Tarrytown, N.Y., and CERAFLOUR by BYK-Chemie GmbH, Wesel, Germany. The wax particles 112 preferably have a softening or melting point of at least about 50° C., and more preferably of at least about 100° C.

The wax particles 112 can have any of a number of suitable shapes and sizes. In preferred embodiments, the wax particles 112 are spherical and micronized. The wax particles 112 preferably have a mass-median-diameter (D₅₀) of at least 0.2 micrometers, at least 0.5 micrometers, at least 1 micrometer, at least 2 micrometers, or at least 5 micrometers. Preferably, the wax particles 112 have a D₅₀ of at most 10 micrometers, at most 50 micrometers, at most 40 micrometers, at most 30 micrometers, at most 20 micrometers, or at most 10 micrometers.

In some cases, the wax particles 112 may be provided as a wax dispersion in a suitable organic solvent. For particulate dispersions, a Hegman gauge (or grind gauge) can be used to approximate the sizes of the coarsest dispersed particles. The Hegman particle diameter for the wax particles 112 in dispersed form can optionally be at least 5 micrometers, at least 10 micrometers, at least 15 micrometers, at least 20 micrometers, at least 25 micrometers, or at least 30 micrometers. The Hegman particle diameter for the wax particles 112 may optionally be at most 50 micrometers, at most 45 micrometers, at most 40 micrometers, at most 35 micrometers, at most 30 micrometers, or at most 25 micrometers.

The wax particles 112 preferably have a density that facilitates compounding of the wax particles 112 in precursor resins used the make the polymeric layer 110. The density can be, for example, close to the density of the release coating fluid prior to its curing.

In some embodiments, the wax particles 112 have a density of at least 0.7 grams per cubic centimeter, at least 0.8 grams per cubic centimeter, at least 0.9 grams per square centimeter, at least 0.92 grams per cubic centimeter, or at least 0.95 grams per cubic centimeter. In some embodiments, the wax particles 112 can have a density of at most 2.5 grams per cubic centimeter, at most 2 grams per cubic centimeter, at most 1.5 grams per cubic centimeter, at most 1.4 grams per cubic centimeter, or at most 1.3 grams per cubic centimeter.

While not particularly restricted, the wax particles 112 can represent a significant portion of the first release coating 108. In some embodiments, the wax particles 112 represent at least 0.1% percent, at least 0.3% percent, or at least 0.5% percent, based on the overall weight of solids in the first release coating 108. In some embodiments, the wax particles 112 represent at most 5 percent, at most 6 percent, or at most 7 percent, based on the overall weight of solids in the first release coating 108.

When disposed at the surface of the first release coating 108, the wax particles 112 reduce the extent of direct contact between the polymeric layer 110 and an adhesive, such as a pressure-sensitive adhesive, placed in contact with the first release coating 108.

In preferred embodiments, the first release coating 108 is thin and appears, macroscopically, smooth and uniform. The first release coating 108 can have an average thickness (including the embedded wax particles 112) of at least 0.2 micrometers, at least 0.35 micrometers, at least 0.5 micrometers, at least 0.75 micrometers, at least 1 micrometer, or at least 1.25 micrometers. In the same or alternative embodiments, the overall first release coating 108 can have an average thickness of at most 250 micrometers, at most 200 micrometers, at most 180 micrometers, at most 150 micrometers, at most 130 micrometers, at most 100 micrometers, or at most 90 micrometers.

Referring again to FIG. 1, a second release coating 116 extends across and contacts the second major surface 106 of the backing 102. Like the first release coating 108, the second release coating 116 facilitates detachment of an adhesive layer, such as a pressure-sensitive adhesive layer, disposed thereon.

Unlike the first release coating 108, however, the second release coating 116 is substantially free of any embedded or partially embedded wax particles. In some embodiments, the second release coating 116 is free of any particles that affect the surface topology of the exposed surface of the second release coating 116. In further embodiments, the second release coating 116 contains particles but these particles do not enhance the release characteristics to the same extent that the wax particles 112 enhance the release characteristics of the first release coating 108, particularly after subjecting the release liner 100 to irradiation with an electron beam.

In a preferred embodiment, the exposed surface of the second release coating 116 is generally planar, as shown, to assist in the wet out of an adhesive placed in contact with the second release coating 116. As an alternative, the second release coating 116 can have a texture that assists with bleeding out entrapped air bubbles and assist with providing some degree of repositionability. These surface textures are described, for example, in U.S. Pat. No. 5,897,930 (Calhoun et al.) and U.S. Patent Publication No. 2006/0127626 (Fleming et al.).

There are no particular restrictions on the features of the second release coating 116 aside from the functional aspects discussed above. For manufacturing convenience, the second release coating 116 could be provided by a polymeric layer substantially similar, or identical, to that of the polymeric layer 110 of the first release coating 108. For example, the second release coating 116 may have a chemical composition, molecular architecture, morphology, and/or film dimensions similar or identical to that of the polymeric layer 110 of the first release coating 108.

The release liner 100 can be made using any known manufacturing method for double-coated liners. In exemplary methods, solutions of release material precursor, derived from reactive monomers, crosslinkers and any additives (such as wax particles 112 on the first major surface 104 of the backing 102), may be initially blended with a diluent. Suitable diluents include, for example, ethyl acetate, butyl acetate, methyl ethyl ketone, methyl isobutyl ketone, hexane, heptane, toluene, xylene, methylene chloride, and mixtures thereof.

The release material precursors can then be coated on respective major surfaces 104, 106 of the backing 102.

Useful coating methods include, for example, bar coating, roll coating (e.g., gravure coating, offset gravure coating (i.e. 3-roll coating), and 5-roll coating), spray coating, curtain coating, metered slot and slide coating, and brush coating. The coating thicknesses of the release material precursor depend in part on formulation and the type of backing 102 selected, but these generally range from 0.01 micrometers to 1 micrometer, and preferably from 0.05 micrometers to 0.5 micrometers.

After the release coating is coated onto the liner backing, the coated liner backing is then cured. Such curing can take place, for example, by irradiation with an electron beam, which will be discussed with greater detail in a later section, visible light, or ultraviolet (UV) light.

Examples of useful UV light sources include high intensity UV lamps, such as H, H+ and D FUSION lamps (commercially available from Fusion UV Curing Systems, Rockville, Md.) and medium pressure mercury lamps. Where significant diluents are used, treatment in a thermal oven also may be needed before UV curing to remove solvents. The irradiation energy of the UV depends on the thickness or composition of the release material precursor layer and is usually from 10 to 300 mJ/cm², preferably from 20 to 150 mJ/cm².

FIG. 2 shows an exemplary transfer tape 150 that includes the release liner 100. As shown, the transfer tape 150 is comprised of the release liner 100 and an adhesive layer 152 that extends across and contacts the major surface of the release liner 100 opposite the first release coating 108. In the preferred embodiment shown, the adhesive layer 152 is a pressure-sensitive adhesive layer hardenable (or curable) through electron beam processing.

The pressure-sensitive adhesive layer of the transfer tape 150 may be comprised of any known pressure-sensitive adhesive. Pressure-sensitive adhesives are a category of adhesives which in dry (or solvent-free) form are aggressively, and permanently, tacky at room temperature. They firmly adhere to a variety of surfaces upon contact without the need of more than finger or hand pressure. Pressure-sensitive adhesives do not require activation by water, solvent, or heat to exert a strong adhesive holding force toward such materials as paper, cellophane, glass, wood, and metals. They are sufficiently cohesive and elastic in nature so that, despite their aggressive tackiness, they can be handled with the fingers and removed from smooth surfaces without leaving a residue. Quantitatively, pressure-sensitive adhesives can be described using the “Dahlquist criteria” which maintains that the elastic modulus of these materials is less than 106 dynes/cm2 at room temperature (see, for example, Pocius, A.V., Adhesion & Adhesives: An Introduction, Hanser Publishers, New York, N.Y., First Edition, 1997).

Exemplary pressure-sensitive adhesives useful for the presently disclosed pressure-sensitive adhesive layers include, but are not limited to, acrylic pressure-sensitive adhesives, rubber pressure-sensitive adhesives, rubber-resin pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorinated pressure-sensitive adhesives, epoxy pressure-sensitive adhesives, block copolymer-based pressure-sensitive adhesives and other known pressure-sensitive adhesives. In a preferred embodiment, acrylic pressure-sensitive adhesives are used. Each of the different pressure-sensitive adhesives can be used alone or in combination. The particular pressure-sensitive adhesives used are not critical, and examples could include emulsion pressure-sensitive adhesives, solvent-borne pressure-sensitive adhesives, photo-polymerizable pressure-sensitive adhesives and hot melt pressure-sensitive adhesives (i.e., hot melt extruded pressure-sensitive adhesives).

Acrylic pressure-sensitive adhesives include pressure-sensitive adhesives containing an acrylic polymer as a base polymer (or base resin). Though not so limited, the acrylic polymer can be prepared by subjecting to polymerization (or copolymerization) one or more alkyl (meth)acrylates as essential monomer components (main monomer components) and, where necessary, one or more monomers copolymerizable with the alkyl (meth)acrylates. Exemplary copolymerizable monomers include polar-group-containing monomers and multifunctional monomers. The polymerization can be performed, without limitation, according to any technique known in the art, such as UV polymerization, solution polymerization, or emulsion polymerization.

Alkyl (meth)acrylates for use as main monomer components of the acrylic polymer herein are alkyl (meth)acrylates each having a linear or branched-chain alkyl group, and examples include alkyl (meth)acrylates whose alkyl moiety has 1 to 20 carbon atoms, such as methyl (meth)acrylates, ethyl (meth)acrylates, propyl (meth)acrylates, isopropyl (meth)acrylates, butyl (meth)acrylates, isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth) acrylates, 2-ethylhexyl (meth) acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth) acrylates, tridecyl (meth) acrylates, tetradecyl (meth) acrylates, pentadecyl (meth) acrylates, hexadecyl (meth)acrylates, heptadecyl (meth) acrylates, octadecyl (meth)acrylates, nonadecyl (meth)acrylates, and eicosyl (meth)acrylates. Among these, alkyl (meth)acrylates whose alkyl moiety has 2 to 14 carbon atoms are preferred, and alkyl (meth)acrylates whose alkyl moiety has 2 to 10 carbon atoms are particularly preferred.

As a primary monomer component of the acrylic polymer, alkyl (meth)acrylates represent, in some embodiments, 60 percent by weight or more, and in other embodiments 80 percent by weight or more, based on the total amount of monomer components for constituting the acrylic polymer. The acrylic polymer may further contain, as monomer components, one or more copolymerizable monomers such as polar-group-containing monomers and multifunctional monomers. The presence of copolymerizable monomers as monomer components may, in some embodiments, provide the pressure-sensitive adhesive with improved adhesive strength to an adherend and/or a higher cohesive strength. Each of the different copolymerizable monomers can be used alone or in combination with others.

Exemplary polar-group-containing monomers include carboxyl-containing monomers such as (meth)acrylic acids, itaconic acid, maleic acid, fumaric acid, crotonic acid, and isocrotonic acid, along with anhydrides of them, such as maleic anhydride; hydroxyl-containing monomers including hydroxyalkyl (meth)acrylates such as hydroxyethyl (meth)acrylates, hydroxypropyl (meth) acrylates, and hydroxybutyl (meth)acrylates; amido-containing monomers such as acrylamide, methacrylamide, N,N-dimethyl(meth)acrylami des, N-methylol(meth)acrylamides, N-methoxymethyl(meth)-acrylamides, and N-butoxymethyl(meth)acrylamides; amino-containing monomers such as aminoethyl (meth)acrylates, dimethylaminoethyl (meth)acrylates, and t-butylaminoethyl (meth) acrylates; glycidyl-containing monomers such as glycidyl (meth)acrylates and methylglycidyl (meth)acrylates; cyano-containing monomers such as acrylonitrile and methacrylonitrile; heterocycle-containing vinyl monomers such as N-vinyl-2-pyrrolidone, (meth)acryloylmorpholines, N-vinylpyridine, N-vinylpiperidone, N-vinylpyrimidine, N-vinylpiperazine, N-vinylpyrrole, N-vinylimidazole, N-vinyloxazole, and N-vinylcaprolactam; alkoxyalkyl (meth)acrylate monomers such as methoxyethyl (meth)acrylates and ethoxyethyl (meth)acrylates; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxy-ethyl isocyanate.

Of the aforementioned polar-group-containing monomers, acrylic acid and other carboxyl-containing monomers, and anhydrides thereof, are preferred. The amount of polar-group-containing monomers present is typically 30 percent by weight or less (e.g., from 0.1 to 30 percent by weight), and preferably from 0.1 to 15 percent by weight, based on the total amount of monomer components in the acrylic polymer. Polar-group-containing monomers, if used in an amount of more than 30 percent by weight, may cause the acrylic pressure-sensitive adhesive to have an excessively high cohesive strength and thereby show insufficient tackiness. Conversely, polar-group-containing monomers, if used in an excessively small amount (e.g., less than 1 percent by weight based on the total amount of monomer components in the acrylic polymer) may not satisfactorily provide the acrylic pressure-sensitive adhesive with a sufficient cohesive strength and/or a sufficiently high shearing force.

Examples of the multifunctional monomers include hexanediol di(meth)acrylates, butanediol di(meth)acrylates, (poly)ethylene glycol di(meth)acrylates, (poly)propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethyloipropane tri(meth)acrylates, tetramethylolmethane tri(meth)acrylates, allyl (meth)acrylates, vinyl (meth)acrylates, divinylbenzene, epoxy acrylates, polyester acrylates, and urethane acrylates.

The amount of multifunctional monomers present is typically 2 percent by weight or less (e.g., from 0.01 to 2 percent by weight) and preferably 0.02 to 1 percent by weight, based on the total amount of monomer components in the acrylic polymer. Multifunctional monomers, if used in an amount of more than 2 percent by weight of the total amount of monomer components in the acrylic polymer, may cause the acrylic pressure-sensitive adhesive to have an excessively high cohesive strength, resulting in insufficient tackiness. Multifunctional monomers, if used in an excessively small amount (e.g., less than 0.01 percent by weight of the total amount of monomer components for constituting the acrylic polymer), may not provide the acrylic pressure-sensitive adhesive with a sufficient cohesive strength.

In addition to the polar-group-containing monomers and multifunctional monomers, exemplary copolymerizable monomers usable herein further include vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride. Exemplary copolymerizable monomers further include (meth)acrylates each having an alicyclic hydrocarbon group, such as cyclopentyl (meth)acrylates, cyclohexyl (meth)acrylates, and isobornyl (meth)acrylates.

The pressure-sensitive adhesive layer 152 may contain one or more suitable additives. Exemplary additives usable herein include silanes, tackifiers (e.g., rosin esters, terpenes, phenols, and aliphatic, aromatic, or mixtures of aliphatic and aromatic synthetic hydrocarbon resins), crosslinking agents (e.g., polyisocyanate compounds, silicone compounds, epoxy compounds, and alkyl-etherified melamine compounds), surfactants, plasticizers (other than physical blowing agents), nucleating agents (e.g., talc, silica, or titanium dioxide), fillers (e.g., glass or polymeric low-density microspheres), fibers, age inhibitors, antioxidants, UV-absorbers, antistatic agents, lubricants, pigments, dyes, reinforcing agents, hydrophobic or hydrophilic silica, calcium carbonate, toughening agents, flame retardants, finely ground polymeric particles (e.g., polyester, nylon, or polypropylene), stabilizers (e.g., UV stabilizers), colorants (e.g., dyes and pigments such as carbon black), and combinations thereof.

In some embodiments, the pressure-sensitive adhesive is an acrylic pressure-sensitive adhesive containing a high glass transition temperature oligomer (“HTGO”). Advantageously, the addition of an HTGO can provide a micro-domain phase morphology that enhances adhesion to low surface energy surfaces and creep resistance at high temperatures. Further options and advantages associated with HTGOs are described, for example, in U.S. Patent Publication No. 2015/0044457 (Chen et al.).

The composition used in the pressure-sensitive adhesive layer can be prepared by mixing a base polymer, any additives, and any other components using known methods to form an adhesive precursor. This adhesive precursor is coated onto the exposed face of the second release coating 116 of the release liner 100 and subsequently cured to form the adhesive layer 152.

Advantageously, the adhesive layer 152 is cured by electron beam radiation. Electron beam radiation is beneficial because it can crosslink, on demand, compositions that are normally difficult to penetrate with UV or visible light, such as highly pigmented adhesives, adhesives containing fillers, and relatively thick layers of adhesives. Additionally, use of an electron beam to cure the adhesive enables the transfer tape to be made with higher purity. For example, the composition of adhesive layer 152 can be formulated to be substantially free of any thermal or photochemical initiators.

Electron beam radiation causes crosslinking of the adhesive by initiating a free-radical chain reaction. Ionizing radiation from the electron beam is absorbed directly in the polymer and generates free radicals that initiate the crosslinking process. Generally, electron energies of about 100 keV are necessary to break chemical bonds and ionize, or excite, components of the polymer system. Therefore, the scattered electrons that are produced to a large population of free radicals throughout the adhesive. These radicals initiate the polymerization reaction. This polymerization process results in a three-dimensional crosslinked polymer.

An electron beam processing unit supplies the radiation for this process. Generally, a processing unit includes a power supply and an electron beam acceleration tube. The power supply increases and rectifies the current, and the accelerator generates and focuses the electron beam and controls the scanning. The electron beam may be produced, for example, by energizing a tungsten filament with high voltage, allowing electrons to be produced at high rates. These electrons are then concentrated to form a high energy beam and are accelerated to full velocity inside the electron gun. Electromagnets on the sides of the accelerator tube allow deflection, or scanning, of the beam.

Scanning widths can range from 60 to 180 centimeters and scanning depths can range from 10 to 15 centimeters. The scanner opening is covered with a thin metal foil, usually titanium, which allows passage of electrons, but maintains a high vacuum. Characteristic power, current, and dose rates of accelerators are about 200-500 keV, about 25-200 milliamps (mA) and about 1-10 megarads (Mrads), respectively.

The first release coating 108 preferably provides a release force of at least 0.015 newtons per centimeter according to the 180° Angle Peel Adhesion Test, described in the forthcoming Examples. In preferred embodiments, the release force is at most 0.15 newtons per centimeter, at most 0.12 newtons per centimeter, at most 0.077 newtons per centimeter, at most 0.058 newtons per centimeter, or at most 0.039 newtons per centimeter according to the 180° Angle Peel Adhesion Test.

Preferably, both the first and second release coatings 108, 116 leave behind minimal residual contaminants on the surface of the adhesive layer 152 after being peeled away from the adhesive layer 152.

FIG. 3 shows a transfer tape 250 according to another exemplary embodiment. The transfer tape 250 bears many similarities to the transfer tape 150, including, in the following order, a first release coating 208 (comprised of wax particles 212 partially embedded in a polymeric layer 210), a backing 202, a second release coating 216, and an adhesive layer 252.

The transfer tape 250 differs from the prior embodiment, however, in that the adhesive layer 252 itself has a multilayered construction. As depicted in the figure, the adhesive layer 252 includes a first adhesive skin layer 254 and second adhesive skin layer 256 disposed on opposing first and second sides of a foamed adhesive layer 258. The skin layers 254, 256 are not foamed.

Use of a foamed adhesive layer 258 as a core layer can provide enhanced adhesion. A compressible foam can enable better conformability to substrates having rough or uneven surfaces. The use of a foam can allow stress to be distributed evenly throughout the length of the adherend surfaces and prevent localization of stress at the adhesive bond line. Further, foamed adhesives can provide improved shock and impact resistance relative to their unfoamed counterparts, in addition to features such as sound and vibration damping for specialized applications.

The foamed adhesive layer 258 can be foamed using any known foaming mechanism or agent capable. For example, this layer may be comprised of syntactic foams where hollow particles are blended into a polymer matrix or, alternatively, non-syntactic foams where a cellular structure is formed from stabilized gas bubbles borne from a physical or chemical blowing agent. In the case of syntactic foams, expandable polymeric microspheres can be advantageously used to prepare closed cell foams with highly controlled cellular microstructures. Particulars concerning suitable foamed adhesive compositions are described in U.S. Patent Publication No. 2015/0030839 (Satrijo et al.).

To enhance interlayer adhesion, the foamed adhesive layer 258 may use the same or similar adhesive resin components as that of the first and second skin layers 254, 256.

FIG. 4 shows a transfer tape 350 according to still another exemplary embodiment. The transfer tape 350 includes all of the layers of the transfer tape 250, namely a backing 302 coated on both sides with first and second release coatings 308, 316 (representing a first release liner 300) and a three-layered adhesive layer 352 disposed on the second release coating 316. As shown, the transfer tape 350 further includes a second release liner 358. The second release liner 358 includes a second backing 360 and a third release coating 362, where the adhesive layer 352 extends across and contacts the third release coating 362.

As an option, the backing 360 and third release coating 362 can have features that are substantially the same as, or similar to, those of the backing 302 and second release coating 316, respectively.

The second release liner 358 can provide a manufacturing advantage by protecting both major surfaces of the adhesive layer 352 before and, optionally, after curing. This feature can facilitate, for example, web handling of the transfer tape and allow adjustment of the adhesive layer 352 thickness by passing the adhesive coated web between nip rollers prior to the curing step.

Here, the second release liner 358 is part of the final packaged product and is provided in sheet form, from which it can be conveniently die cut to a desired shape for the application at hand. The transfer tape 350 could also be rolled upon itself with both release liners intact. In this configuration, the particle-embedded first release surface 308 does not exhibit blocking even when placed in contact with the third release liner 360 for extended periods of time.

In an alternative method, the second release liner 358 is peeled away from the adhesive layer 352 subsequent the coated web passing through the nip rollers but prior to electron beam curing. In this case, the final product could have a layered configuration akin to the transfer tape 250 shown previously in FIG. 3, for winding and storage in roll form.

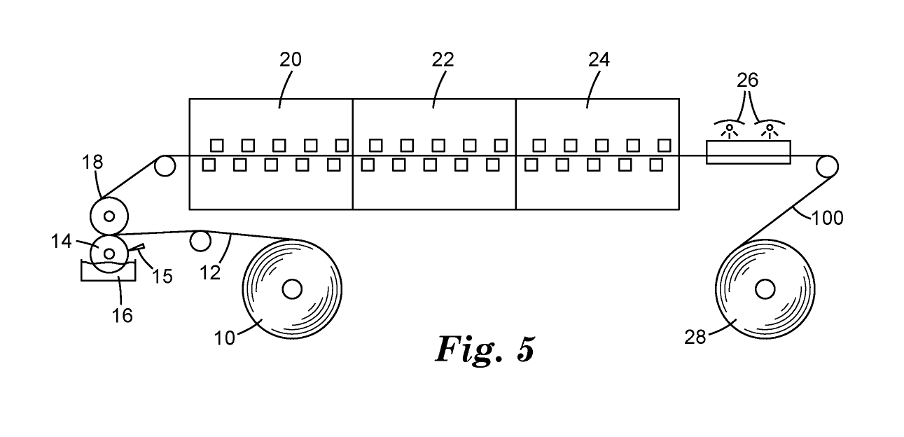

FIG. 5 shows an exemplary process of making the release liner 100 by gravure coating. In this method, a container 16 of a curable resin dispersion used to prepare the polymeric layer 110 and particles 112 of the first release coating 108. This resin dispersion is entrained in a textured surface of a gravure roll 14 that is partially submerged in the resin and rotates counterclockwise. To provide a consistent coating weight, excess resin is scraped away by a doctor blade 15.

A conventional single-sided liner, representing the backing 12 and second release coating 116, is dispensed with its release coating facing up from a liner feed roll 10 as shown. The liner is then guided into contact with the resin-bearing gravure roll 14 by an opposing backup roll 18. A uniform coating of the resin is thus transferred from the gravure roll 14 to the previously uncoated surface of the backing 12 as it emerges from the gap between the gravure roll 14 and the backup roll 18. Further options and advantages associated with gravure coating are described, for example, in U.S. Pat. No. 7,645,355 (Bilski et al.).

The coated web is then conveyed through a series of heated ovens 20, 22, 24 to drive off any residual solvent entrained in the curable resin. Based on the web speed and the nature of the resin coating, the temperature profile of the ovens 20, 22, 24 can be selected to maximize the efficiency of this process.

Finally, the coated resin dispersion is cured by passing the web through an UV light source 26 to provide the finished liner 100, which is wrapped around take-up roll 28. It is understood that the liner 100 at this point may only be partially cured. Nonetheless, the presence of the particles 112 in the first release coating 108 prevents undesirable adhesion of the liner 100 to itself during its storage on the take up roll 28.

As another possibility, the web can be passed beneath the UV light source 26 prior to entering the heated ovens 20, 22, 24, which can help accelerate the rate of the curing reactions.

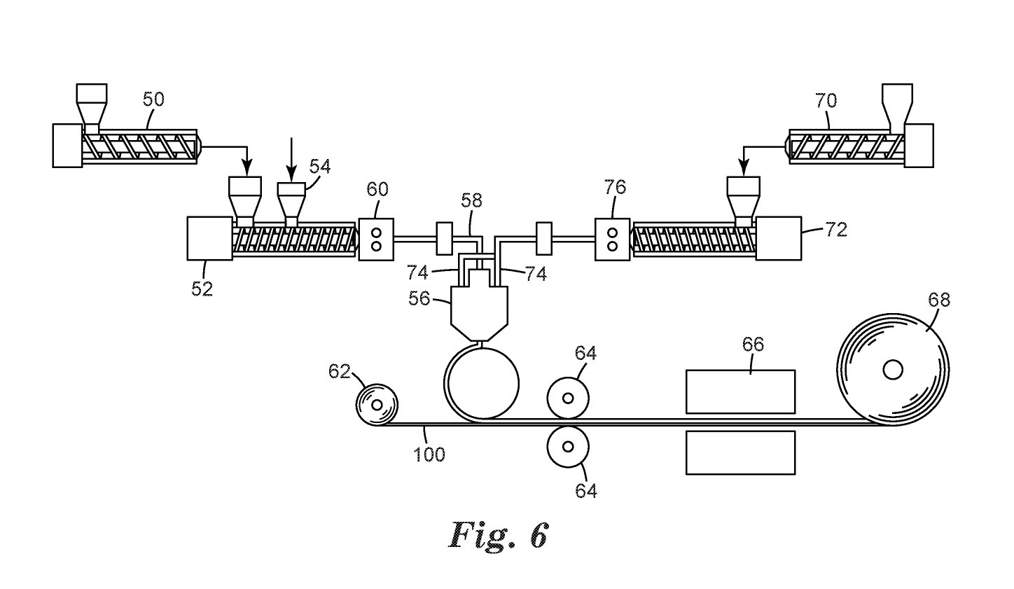

FIG. 6 shows an exemplary process of preparing the transfer tape 250 from the release liner 100 and syntactic foam adhesive precursor components. The left side of the diagram shows the processing of a first polymer resin used for the continuous matrix of the foam adhesive. This polymer resin is fed into a first extruder 50 that softens and grinds the resin into smaller particles suitable for extrusion. The first polymer resin can take the form of pellets, billets, strands, or ropes. This step may be omitted if the polymer resin is already in a form suitable for extrusion.

The resin particles and other additives, except for expandable microspheres, are fed into a second extruder 52 at a position prior to the kneading zone of the extruder 52, where they are conveyed into the kneading zone and thoroughly mixed together. Mixing is preferably carried out here at temperatures insufficient to cause expansion of microspheres.

Expandable microspheres are then added to the extruded mixture at a downstream entrance 54 to the extruder 52 and further mixed to form an expandable extrudable composition in which the microspheres are homogenously distributed in the melt. The expandable extrudable composition is then metered into a die 56 through transfer tubing 58 using a gear pump 60. While the temperatures of the die 56 and transfer tubing 58 are preferably at or above the temperature capable of inducing expansion of the microspheres, the metering of the gear pump 60 regulates the internal pressure and prevents foaming within the transfer tubing 58.

In a preferred embodiment, the microspheres expand within the die 56 and the fully foamed, but uncured, composition extrudes in a continuous sheet onto the release liner 100. In FIG. 6, the release liner 100 is dispensed from a feed roll 62 with the first release coating 108 facing downward (or outwardly with respect to the feed roll 62). The adhesive precursor and the release liner 100 are then passed between nip rollers 64 and collectively irradiated by electron beam source 66, which crosslinks the adhesive precursor to provide the finished transfer tape 150, which is rolled up on take-up roll 68.

In this exemplary process, the nip rollers 64 are surface treated or constructed from suitable materials to prevent coated adhesive precursor(s) from sticking to the nip rollers 64. Alternatively, but not shown, a second release liner can be disposed onto the open-faced surface of the coated adhesive precursor(s) at a location preceding the nip rolls 64. The second liner can then be stripped off either before or after the curing step carried out by the electron beam source 66.

If desired, additional electron beam sources can be inserted after electron beam source 66 to enable two or more electron beam curing operations to take place and obtain a more thorough polymerization of the adhesive precursor.

Optionally and as shown in FIG. 6, additional polymer components can be included in the transfer tape. Here, the adhesive foam is sandwiched between a pair of skin layers by adding a polymer resin to a third extruder 70, which grinds the polymer into particles suitable to be fed into a fourth extruder 72. In the fourth extruder the particles are melted and mixed into any desired additives and again metered into the die 56 through a matching pair of transfer tubes 74 with the assistance of gear pump 76.

By virtue of coextruding the uncured polymer skin layers with the uncured foamed layer through the die 56, the resulting article has a foamed core symmetrically disposed between a pair of non-foamed skins.

When the finished transfer tape is wound up onto the take-up roll 68, the inward-facing skin layer contacts the first release coating 108 (containing the wax particles 112) while the outward-facing skin layer contacts the second release coating 116 (devoid of wax particles).

To avoid liner confusion when the finished transfer tape is unwound from its take-up roll, it is preferred that the first release coating 108 provides a significantly lower release force from the adhesive layer 152 than the second release coating 116. In preferred embodiments, the first release coating 108 provides a release force of at least 1 percent that of the second release coating 116, while providing a release force of at most 70 percent, at most 65 percent, at most 60 percent, at most 55 percent, or at most 50 percent that of the second release coating 116.

While not intended to be limiting, particular embodiments of the aforementioned transfer tapes, bondable assemblies, and methods of making the same are enumerated as follows:

1. A method of making a transfer tape comprising: disposing first and second release coatings onto respective first and second major surfaces of a backing to provide a release liner, the first release coating comprising wax particles at least partially embedded in a polymeric layer; coating an adhesive precursor onto the first release coating; and collectively irradiating the adhesive precursor and the release liner with an electron beam to convert the adhesive precursor into an adhesive layer.

2. The method of embodiment 1, wherein the second release coating is substantially free of wax particles.

3. The method of embodiment 1 or 2, wherein the adhesive precursor comprises an uncured foamed adhesive layer.

4. The method of embodiment 3, wherein the adhesive precursor further comprises a pair of uncured adhesive skin layers disposed on opposite sides of the uncured foamed adhesive layer.

5. The method of any one of embodiments 1-4, wherein the polymeric layer comprises a silicone, fluoro-silicone, silicone acrylate, perfluoropolyether, or copolymer or mixture thereof.

6. The method of embodiment 5, wherein the polymeric layer comprises a silicone cured by ultraviolet light.

7. The method of embodiment 5, wherein the polymeric layer comprises an epoxy silicone.

8. The method of embodiment 7, wherein the epoxy silicone is cured by photo-acid generated crosslinking.

9. The method of any one of embodiments 1-8, wherein the wax particles comprise modified high-density polyethylene, modified polyethylene, polypropylene, ethylene acrylic acid copolymer, oxidized high-density polyethylene, or a copolymer or mixture thereof.

10. The method of embodiment 9, wherein the wax particles comprise a fluoropolymer.

11. The method of embodiment 10, wherein the fluoropolymer comprises polytetrafluoroethylene.

12. The method of embodiment 10, wherein the fluoropolymer comprises polytetrafluoroethylene-modified polyethylene.

13. The method of any one of embodiments 1-12, wherein the wax particles have a mass-median-diameter (D₅₀) ranging from 2 micrometers to 50 micrometers.

14. The method of embodiment 13, wherein the wax particles have a mass-median-diameter (D₅₀) ranging from 2 micrometers to 30 micrometers.

15. The method of embodiment 14, wherein the wax particles have a mass-median-diameter (D₅₀) ranging from 2 micrometers to 10 micrometers.

16. The method of any one of embodiments 1-15, wherein the wax particles have a density ranging from 0.7 grams per cubic centimeter to 2.5 grams per cubic centimeter.

17. The method of embodiment 16, wherein the wax particles have a density ranging from 0.9 grams per cubic centimeter to 1.5 grams per cubic centimeter.

18. The method of embodiment 17, wherein the wax particles have a density ranging 0.95 grams per cubic centimeter to 1.3 grams per cubic centimeter.

19. The method of any one of embodiments 1-18, wherein the release liner is a first release liner and further comprising disposing a second release liner on the adhesive precursor opposite the first release liner, and collectively directing the first release liner, adhesive precursor, and second release liner between a pair of nip rollers.

20. The method of embodiment 19, further comprising removing the second release liner from the adhesive precursor prior to collectively irradiating the adhesive precursor and release liner.

21. The method of any one of embodiments 1-20, further comprising winding the transfer tape into a roll whereby the adhesive layer simultaneously contacts both the first and second release coatings.

22. The method of any one of embodiments 1-21, wherein the first release coating has a release force ranging from 1 percent to 70 percent of the release force of the second release coating with respect to the adhesive layer based on the 180° Angle Peel Adhesion Test.

23. The method of embodiment 22, wherein the first release coating has a release force ranging from 1 percent to 60 percent of the release force of the second release coating with respect to the adhesive layer based on the 180° Angle Peel Adhesion Test.

24. The method of embodiment 23, wherein the first release coating has a release force ranging from 1 percent to 50 percent of the release force of the second release coating with respect to the adhesive layer based on the 180° Angle Peel Adhesion Test.

25. The method of any one of embodiments 1-24, wherein the backing is selected from paper, ceramic, polyolefin-based resin, polyamide, polyester and combinations thereof.

26. A transfer tape made by the method of any one of embodiments 1-25.

27. A transfer tape comprising: a release liner comprising: a backing having opposed first and second major surfaces; a first release coating disposed on the first major surface comprising wax particles at least partially embedded in a polymeric layer; and a second release coating disposed on the second major surface; and an adhesive layer disposed the second release coating, the adhesive layer being substantially free of thermal and photochemical initiators.

28. The transfer tape of embodiment 27, wherein the adhesive layer comprises a pressure-sensitive adhesive.

29. The transfer tape of embodiment 27 or 28, wherein the transfer tape has a rolled configuration whereby the adhesive layer contacts both the first and second release coatings.

30. The transfer tape of any one of embodiments 27-29, wherein the adhesive layer has a thickness ranging from 25 micrometers to 2500 micrometers.

31. The transfer tape of embodiment 30, wherein the adhesive layer has a thickness ranging from 50 micrometers to 1800 micrometers.

32. The transfer tape of embodiment 31, wherein the adhesive layer has a thickness ranging from 125 micrometers to 900 micrometers.

33. The transfer tape of any one of embodiments 26-32, wherein the second release coating has a release force with respect to the adhesive layer ranging from 0.015 newtons per centimeter to 0.15 grams per centimeter according to the 180° Angle Peel Adhesion Test.

34. The transfer tape of embodiment 33, wherein the second release coating has a release force with respect to the adhesive layer ranging from 0.015 newtons per centimeter to 0.077 grams per centimeter according to the 180° Angle Peel Adhesion Test.

35. The transfer tape of embodiment 34, wherein the second release coating has a release force with respect to the adhesive layer ranging from 0.015 newtons per centimeter to 0.039 grams per centimeter according to the 180° Angle Peel Adhesion Test.

36. A bondable assembly comprising: a transfer tape of any one of embodiments 26-35; and a substrate adhesively coupled to a major surface of the adhesive layer opposite that facing the first release liner.

### EXAMPLES

Objects and advantages of this disclosure are further illustrated by the following non-limiting examples. Particular materials and amounts thereof recited in these examples, as well as other conditions and details, should not be construed to unduly limit this disclosure.

Unless otherwise noted, all parts, percentages, ratios, etc. in the Examples and the rest of the specification are by weight and reagents were obtained, or available, from Sigma-Aldrich Corp. in St. Louis, Mo.

### Anti-Blocking Materials

Wax particles were provided by BYK-Chemie GmbH, in Wesel, Germany. Available material and particle size information for each additive is listed in Table 1.

TABLE 1

| | | Melting | | | Hegman, |
|---|---|---|---|---|---|
| | | point, | Density, | D₅₀, | micro- |
| Additive | Composition | ° C. | g/mL | micrometers | meters |
| C916 | Modified | 135 | 0.99 | 46 | |
| | HDPE | | | | |
| C925 | Modified PE | 115 | 1.06 | 6 | |
| C969 | PTFE | 115 | 1.3 | 6 | |
| | Modified PE | | | | |
| C970 | PP wax | 160 | 0.9 | 9 | |
| C981 | PTFE wax | | 2.28 | 3 | |
| C991 | PE wax | 115 | 0.95 | 5 | |
| CFK103 | 6% EAA | 110 | | | 15 |
| | copolymer wax | | | | |
| | in xylene/butyl | | | | |
| | acetate/n- | | | | |
| | butanol (7/8/1) | | | | |
| CM248 | 20% PE wax in | 110 | | | 20 |
| | aromatic-free | | | | |
| | white spirit | | | | |
| CM258 | 17.5% | 135 | | | 30 |
| | oxidized | | | | |
| | HDPE wax in | | | | |
| | butylacetate | | | | |

Material and particle size information for each comparative anti-blocking additive is given in Table 2.

TABLE 2

| | | | Density at | |
|---|---|---|---|---|
| | | Particle size, | 25° C. | |
| Designation | Composition | micrometers | (g/cm³) | Source |
| ACEMATT | Silica | 6.3 | 2.65 | Evonik |
| HK400 | particles | | | Corporation, |
| (“AHK400”) | | | | Parsippany, NJ |
| TOSPEARL | Microfine | 3 | 1.32 | Momentive |
| 130 | silicone | | | Performance |
| (“T130”) | resin | | | Materials, Inc., |
| | | | | Waterford, NY |

### Adhesive Assembly Fabrication

Release coatings were prepared using the components shown in Table 3. Components were combined at room temperature with mixing until well blended.

TABLE 3
Release Coating base composition

| | Weight | |
|---|---|---|
| Material | (grams) | Source |
| DMS-S12Y01 silanol-terminated | 8.78 | Gelest, Inc., Tullytown, PA |
| polydimethylsiloxane | | |
| SIB-1824 bistriethoxysilyl | 0.98 | Gelest, Inc., Tullytown, PA |
| octane | | |
| Bisdodecylphenyl iodonium | 0.24 | 3M Company, St. Paul, MN |
| hexfluoroantimonate | | |
| Heptane | 14.7 | |
| MEK | 3.6 | |

The standard formulation of Table 3 was compounded with each of the particulate anti-blocking additives in Table 1. For comparative purposes, a separate formulation was prepared that contained no particulate anti-blocking additives. Each additive was used to fabricate three coated liner specimens at three respective additive concentrations: 0.5 wt %, 1.0 wt %, and 2.0 wt %.

To obtain 0.5 wt % additive, 0.0525 grams of particles was added to the standard formulation. To obtain 1.0 wt % additive, 0.101 grams was added to the standard formulation. To obtain 5.0 wt % additive, 0.525 grams was added to the standard formulation.

Once thoroughly mixed, each composition was coated using a #8 Mayer bar onto 76 micrometer thick HOSTAPHAN 3SAC primed polyethylene terephthalate (PET) provided by Mitsubishi Polyester Film Inc., Greer, S.C. at a coat weight of approximately 2.0 g/cm². The coated samples were then irradiated at an exposure time of 2.4 seconds using a Fusion UV H bulb (from Heraeus Noblelight America LLC, Gaithersburg, Md.) for a total UVC dose of 52 mJ/cm² to provide coated liner sheets.

The coated side of each liner sheet was subsequently cured by an electron beam using an ELECTROCURTAIN CB-300 available from Energy Sciences, Inc., Wilmington, Mass., at 7.5 MRads and 300 keV at ambient pressure. Commercially available THIN FOAM VHB ADHESIVE 86420 TRANSFER TAPE (from 3M Company, St. Paul, Minn.) was disposed between a sheet of unprimed 2 mil (51 micrometer) PET film backing (from 3M Company, St. Paul, Minn.) and the coated side of each liner sheet above. The liner sheet, transfer tape, and PET film backing were laminated to each other by manually rolling a rubber roller forward and backward two times over the layered assembly with hand pressure.

### Test Methods

### Liner Release Test

Liner release testing was conducted using a 6 inch (15 cm) wide by 18 inch (46 cm) long sheet of the layered assembly. After allowing the adhesive to dwell in contact with the liner for a pre-determined time (specified in Table 4), the liner was removed from the transfer tape in a 180° angle peel mode and at a peel rate of 90 inches per minute (229 cm/minute), with force continuously measured using an I-MASS tester (Model SP-2000 Slip/Peel Tester), available from I-MASS, Inc., Accord (Hingham), MA. The platen was made of aluminum and the sample was attached to the platen surface using screw-adjustable clamps.

Liner Release, or the force necessary to peel the liner from the transfer tape, was measured based on an integrated average over a 5 second test period in grams per centimeter (g/cm). Each reported release value represents the average of two replicated measurements.

### 180° Angle Peel Adhesion Test

A one inch (2.5 cm) wide by 6 inch (15 cm) long sample strip was cut from the laminated adhesive sheet with the PET backing as prepared for the Liner Release Test. The liner was then removed and the exposed adhesive side of the foam tape was bonded to a glass test panel by rolling over it four times with a 4.5 lb. (2.0 kg) roller. The 180° angle peel adhesion force was then measured at a peel rate of 12 inches per minute (30 cm/minute) and was measured using the I-MASS tester above. 180° Angle Peel Adhesion was measured in grams per cm (g/cm).

Retained Peel Adhesion was then calculated based on the measured 180° Angle Peel Adhesion and expressed as a percentage of the 180° Angle Peel Adhesion of a control specimen in which the 86420 TRANSFER TAPE (which is removed from its own pre-packaged release liner) was laminated to the PET film backing and directly adhered to the glass substrate. Each peel adhesion test was run twice and the results averaged.

### Test Results

Both the Liner Release Test and 180° Angle Peel Adhesion Test were performed on selected samples under various aging conditions, shown in Table 4, with results shown on the same table. Humidity was controlled at 50% during the testing of these samples.

TABLE 4

| | | 1 day 25° C. | | 7 day 25° C. | | 7 day 50° C. | |
|---|---|---|---|---|---|---|---|
| | | | Retained | | Retained | | Retained |
| | | Liner | Peel | Liner | Peel | Liner | Peel |
| | | Release | Adhesion | Release | Adhesion | Release | Adhesion |
| Additive | Wt. % | (g/cm) | (%) | (g/cm) | (%) | (g/cm) | (%) |
| None | 0 | 15.6 | 109.9 | 12.2 | 84.8 | 12.9 | 80.2 |
| C991 | 0.5 | 14.3 | 118.9 | 13.8 | 94.4 | 12.3 | 88.1 |
| C991 | 1 | 15.4 | 111.4 | 13.1 | 84.2 | 15.8 | 97.5 |
| C991 | 5 | 15.2 | 102.2 | 14.5 | 88.6 | 14.8 | 89.5 |
| C969 | 0.5 | 17.2 | 103.2 | 13.9 | 95.8 | 18.3 | 98.5 |
| C969 | 1 | 15.2 | 110.4 | 14.4 | 91.6 | 16.1 | 93.8 |
| C969 | 5 | 17.0 | 119.5 | 14.1 | 86.3 | 14.3 | 90.0 |
| AHK400 | 1 | 22.0 | 89.1 | 21.4 | 85.8 | 23.2 | 86.2 |
| AHK400 | 5 | 43.4 | 70.1 | 37.2 | 72.3 | 43.7 | 66.1 |
| T130 | 1 | 13.8 | 104.2 | 12.6 | 96.9 | 14.5 | 114.0 |
| T130 | 5 | 28.2 | 107.1 | 23.5 | 100.3 | 16.4 | 107.2 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method of making a transfer tape comprising:
disposing first and second release coatings onto respective first and second major surfaces of a backing to provide a release liner, the first release coating comprising wax particles at least partially embedded in a polymeric layer;
coating an adhesive precursor onto the second release coating; and
collectively irradiating the adhesive precursor and the release liner with an electron beam to convert the adhesive precursor into an adhesive layer.

2. The method of claim 1, wherein the second release coating is substantially free of wax particles.

3. The method of claim 1, wherein the adhesive precursor comprises an uncured foamed adhesive layer.

4. The method of claim 3, wherein the adhesive precursor further comprises a pair of uncured adhesive skin layers disposed on opposite sides of the uncured foamed adhesive layer.

5. The method of claim 1, wherein the polymeric layer comprises a silicone, fluoro-silicone, silicone acrylate, perfluoropolyether, or copolymer or mixture thereof.

6. The method of claim 1, wherein the wax particles comprise modified high-density polyethylene, modified polyethylene, polytetrafluoroethylene-modified polyethylene, polypropylene, fluoropolymer, ethylene acrylic acid copolymer, oxidized high-density polyethylene, or a copolymer or mixture thereof.

7. The method of claim 1, wherein the wax particles have a mass-median-diameter (D₅₀) ranging from 0.2 micrometers to 50 micrometers.

8. The method of claim 7, wherein the wax particles have a mass-median-diameter (D₅₀) ranging from 1 micrometer to 30 micrometers.

9. The method of claim 8, wherein the wax particles have a mass-median-diameter (D50) ranging from 5 micrometers to 10 micrometers.

10. The method of claim 1, further comprising winding the transfer tape into a roll whereby the adhesive layer simultaneously contacts both the first and second release coatings.

11. The method of claim 1, wherein the second release coating has a release force ranging from 1 percent to 70 percent of the release force of the first release coating with respect to the adhesive layer based on the 180° Angle Peel Adhesion Test.

12. A transfer tape made by the method of claim 1.

13. A transfer tape comprising:
a release liner comprising:
a backing having opposed first and second major surfaces;
a first release coating disposed on the first major surface comprising wax particles at least partially embedded in a polymeric layer; and
a second release coating disposed on the second major surface; and
an adhesive layer disposed the first release coating, the adhesive layer being substantially free of thermal and photochemical initiators.

14. The transfer tape of claim 13, wherein the transfer tape has a rolled configuration whereby the adhesive layer contacts both the first and second release coatings.

15. A bondable assembly comprising:
the transfer tape of claim 12; and
a substrate adhesively coupled to a major surface of the adhesive layer opposite that facing the first release liner.

16. The method of claim 2, wherein the adhesive precursor comprises an uncured foamed adhesive layer.

17. The method of claim 16, wherein the adhesive precursor further comprises a pair of uncured adhesive skin layers disposed on opposite sides of the uncured foamed adhesive layer.

18. The method of claim 3, wherein the polymeric layer comprises a silicone, fluoro-silicone, silicone acrylate, perfluoropolyether, or copolymer or mixture thereof; and wherein the wax particles comprise modified high-density polyethylene, modified polyethylene, polytetrafluoroethylene-modified polyethylene, polypropylene, fluoropolymer, ethylene acrylic acid copolymer, oxidized high-density polyethylene, or a copolymer or mixture thereof.

19. The method of claim 4, wherein the polymeric layer comprises a silicone, fluoro-silicone, silicone acrylate, perfluoropolyether, or copolymer or mixture thereof; and wherein the wax particles comprise modified high-density polyethylene, modified polyethylene, polytetrafluoroethylene-modified polyethylene, polypropylene, fluoropolymer, ethylene acrylic acid copolymer, oxidized high-density polyethylene, or a copolymer or mixture thereof.

20. The method of claim 17, wherein the polymeric layer comprises a silicone, fluoro-silicone, silicone acrylate, perfluoropolyether, or copolymer or mixture thereof; and wherein the wax particles comprise modified high-density polyethylene, modified polyethylene, polytetrafluoroethylene-modified polyethylene, polypropylene, fluoropolymer, ethylene acrylic acid copolymer, oxidized high-density polyethylene, or a copolymer or mixture thereof.
